(19) United States
(12) Patent Application Publication
(10) Pub. No.: US 2025/0014463 A1
(43) Pub. Date: Jan. 9, 2025

(54) SIDELINK POSITIONING-BASED TRAFFIC CONTROL

(71) Applicant: QUALCOMM Incorporated, San Diego, CA (US)

(72) Inventor: Dan Vassilovski, Del Mar, CA (US)

(21) Appl. No.: 18/348,181

(22) Filed: Jul. 6, 2023

(51) Int. Cl. G08G 1/08; G08G 1/01

(52) U.S. Cl. CPC G08G 1/08; G08G 1/0125

(57) ABSTRACT

This disclosure provides systems, methods, and devices for wireless communication that support supports sidelink positioning-based traffic control. In a first aspect, a method of wireless communication includes receiving position data associated with one or more vehicles based on a positioning request. The method also includes controlling a traffic control device based on road congestion information. The road congestion information is based on the position data. Other aspects and features are also claimed and described.

### TECHNICAL FIELD

Aspects of the present disclosure relate generally to wireless communication systems, and more particularly, to sidelink positioning-based traffic control. Some features may enable and provide improved communications, including improved traffic control, a reduction in traffic accidents, or a combination thereof.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks may be multiple access networks that support communications for multiple users by sharing the available network resources.

A wireless communication network may include several components. These components may include wireless communication devices, such as base stations (or node Bs) that may support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on a downlink to a UE or may receive data and control information on an uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

A growing focus of research in wireless networks is the intersection of wireless communications and autonomous and semi-autonomous vehicles. Along with advances in autonomous vehicles, there is a push for improvements to traffic control devices and other roadside devices. One such example of a traffic control device is a freeway on-ramp light or sign, also referred to as a freeway on-ramp gating device, that displays a particular color or message when cars are permitted to enter the freeway from the on-ramp. In order to determine when cars may enter the freeway, the freeway on-ramp light may process sensor data to determine a congestion of the freeway in order for use in determining when cars may safely enter the freeway given current conditions. Typically, these sensors include three types of sensors: sensors underneath each freeway lane, sensors under each on-ramp lane near the freeway entrance, and sensors under each on-ramp lane near the connection to a feeder surface street. Installing and servicing these sensors can be an invasive process, requiring penetrating the road surface. Damage resulting from weather, seasonal temperature-induced expansion or contraction, or freeway widening all may require road excavation, introducing expense and impacting traffic along the freeway. Another example of a traffic control device is a stop light. In order to provide additionally functionality beyond time-based light control, a traffic light may include or be coupled to cameras or other sensors, such as sensors under a turn lane, that provide information used by the traffic light to change a displayed light or light cycle. Similar to the sensors of the freeway on-ramp light, the sensors and cameras of the traffic light may require time consuming and expensive processes to install or repair, such as excavating the road above the sensors, or the cameras and sensors may be susceptible to time or weather-based conditions, such as darkness, rain, or snow occluding the cameras. As such, typical traffic control devices are associated with significant costs and traffic disruptions to install and repair, and may lose some functionality due to weather or other external conditions, limiting the usefulness of such devices.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

In one aspect of the disclosure, a method for wireless communication is performed by a network entity. The method includes receiving position data associated with one or more vehicles based on a positioning request. The method further includes controlling a traffic control device based on road congestion information. The road congestion information is based on the position data.

In an additional aspect of the disclosure, a network entity includes a memory storing processor-readable code and at least one processor coupled to the memory. The at least one processor is configured to execute the processor-readable code to cause the at least one processor to receive position data associated with one or more vehicles based on a positioning request. The at least one processor is further configured to control a traffic control device based on road congestion information. The road congestion information is based on the position data.

In an additional aspect of the disclosure, an apparatus for wireless communication includes means for receiving position data associated with one or more vehicles based on a positioning request. The apparatus further includes means for controlling a traffic control device based on road congestion information. The road congestion information is based on the position data.

In an additional aspect of the disclosure, a non-transitory, computer-readable medium stores instructions that, when executed by a processor, cause the processor to perform operations. The operations include receiving position data associated with one or more vehicles based on a positioning request. The operations further include controlling a traffic control device based on road congestion information. The road congestion information is based on the position data.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of an example wireless communication system according to one or more aspects.

FIG. 2 is a block diagram illustrating examples of a base station and a user equipment (UE) according to one or more aspects.

FIG. 3 shows a diagram illustrating an example disaggregated base station architecture according to one or more aspects.

FIG. 4 is a block diagram illustrating an example wireless communication system that supports sidelink positioning-based traffic control according to one or more aspects.

FIG. 5A is a diagram illustrating an example of sidelink positioning-based traffic control according to one or more aspects.

FIG. 5B is a diagram illustrating another example of sidelink positioning-based traffic control according to one or more aspects.

FIG. 5C is a diagram illustrating another example of sidelink positioning-based traffic control according to one or more aspects.

FIG. 6 is a flow diagram illustrating an example process that supports sidelink positioning-based traffic control according to one or more aspects.

FIG. 7 is a flow diagram illustrating another example process that supports sidelink positioning-based traffic control according to one or more aspects.

FIG. 8 is a block diagram of an example network entity that supports sidelink positioning-based traffic control according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support sidelink positioning-based traffic control. For example, the present disclosure describes a network entity, such as a roadside unit (RSU), a base station, or another network entity, that receives position data from vehicles or other user equipments (UEs) and that controls a traffic control device based on road congestion information that is based on the position data. To illustrate, the network entity may determine the road congestion information of a portion of a road that is adjacent or assigned to the network entity based on positions of nearby (e.g., within a particular range) vehicles. The positions may be determined based on position data that is received via sidelink communications from one or more vehicles or other UEs, such as using vehicle-to-everything (V2X) communications such as basic safety messages (BSMs), cooperative awareness messages (CAMs), or other types of V2X messages or signaling. The road congestion information may indicate various aspects of congestion (e.g., traffic density) associated with the road, such as vehicle density along the portion of the road, vehicle speeds of vehicles travelling along the portion of the road, inter-vehicle spacing between such vehicles, or a combination thereof. The network entity may analyze the road congestion information and determine openings (e.g., “gaps”) in traffic for use in controlling the traffic control device to enable additional vehicles to enter the road or for other purposes. For example, the traffic control device may include an on-ramp light (or other device) that is integrated in or communicatively coupled to the network entity, and the network entity may cause the traffic control device to display a particular displayable indicator, such as a green light or an image of a moving car, based on a determination that an additional car may enter the road in an opening in the traffic as indicated by the road congestion data. As another example, if the road congestion information indicates that the traffic is in a substantially constant inter-vehicle spacing, the network entity may adjust a signaling frequency of the traffic control device. In other examples, instead of displaying a visual indicator, the traffic control device may send traffic control messages to one or more additional vehicles to cause the additional vehicles to enter the road. Additional implementations described herein support other types of traffic control devices, such as smart traffic lights or digital road signs, for facilitating “smart highways.”

Particular implementations of the subject matter described in this disclosure may be implemented to realize one or more of the following potential advantages or benefits. In some aspects, the present disclosure provides techniques for sidelink positioning-based traffic control. For example, the techniques described provide for control, by a network entity, of a traffic control device based on position data or ranging data received from nearby vehicles via sidelink communications. By providing for position-aware traffic control using sidelink communications, “smart highway” devices such as on-ramp devices or traffic lights may be deployed with increased efficiently and reduced cost as compared to conventional traffic control devices that require expensive and difficult to install and repair components such as sensors buried under roads, or cameras or other components that can be damaged or obscured by weather or lighting conditions. Additionally, the techniques disclosed herein provide improved traffic control (e.g., based on real-time positioning and ranging data communicated via sidelink communications), a reduction in traffic accidents due to improper traffic control, or a combination thereof.

This disclosure relates generally to providing or participating in authorized shared access between two or more wireless devices in one or more wireless communications systems, also referred to as wireless communications networks. In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with UTRANs in the case of a UMTS/GSM network. Additionally, an operator network may also include one or more LTE networks, or one or more other networks. The various different network types may use different radio access technologies (RATs) and RANs.

An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3GPP is a collaboration between groups of telecommunications associations that aims to define a globally applicable third generation (3G) mobile phone specification. 3GPP LTE is a 3GPP project which was aimed at improving UMTS mobile phone standard. The 3GPP may define specifications for the next generation of mobile networks, mobile systems, and mobile devices. The present disclosure may describe certain aspects with reference to LTE, 4G, or 5G NR technologies; however, the description is not intended to be limited to a specific technology or application, and one or more aspects described with reference to one technology may be understood to be applicable to another technology. Additionally, one or more aspects of the present disclosure may be related to shared access to wireless spectrum between networks using different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1 M nodes/km2), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 millisecond (ms)), and users with wide ranges of mobility or lack thereof; and (3) with enhanced mobile broadband including extreme high capacity (e.g., ˜10 Tbps/km2), extreme data rates (e.g., multi-Gbps rate, 100+ Mbps user experienced rates), and deep awareness with advanced discovery and optimizations.

Devices, networks, and systems may be configured to communicate via one or more portions of the electromagnetic spectrum. The electromagnetic spectrum is often subdivided, based on frequency or wavelength, into various classes, bands, channels, etc. In 5G NR two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” (mmWave) band in documents and articles, despite being different from the extremely high frequency (EHF) band (30 GHz-300 GHz) which is identified by the International Telecommunications Union (ITU) as a “mmWave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “mmWave” or the like if used herein may broadly represent frequencies that may include mid-band frequencies, may be within FR2, or may be within the EHF band.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD) design or frequency division duplex (FDD) design; and advanced wireless technologies, such as massive multiple input, multiple output (MIMO), robust mmWave transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD or TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink or downlink scheduling information, data, and acknowledgement in the same subframe. The self-contained integrated subframe supports communications in unlicensed or contention-based shared spectrum, adaptive uplink or downlink that may be flexibly configured on a per-cell basis to dynamically switch between uplink and downlink to meet the current traffic needs.

For clarity, certain aspects of the apparatus and techniques may be described below with reference to example 5G NR implementations or in a 5G-centric way, and 5G terminology may be used as illustrative examples in portions of the description below; however, the description is not intended to be limited to 5G applications.

Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus and methods described herein may be applied to other communications systems and applications than the particular examples provided.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

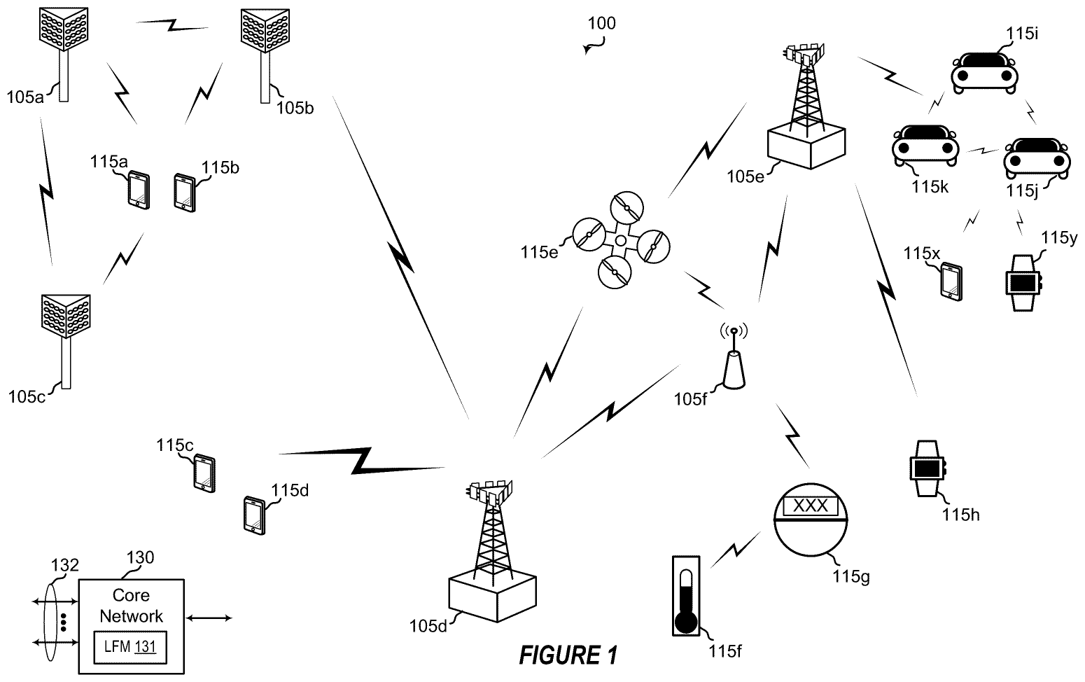

FIG. 1 is a block diagram illustrating details of an example wireless communication system according to one or more aspects. The wireless communication system may include wireless network 100. Wireless network 100 may, for example, include a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” may refer to this particular geographic coverage area of a base station or a base station subsystem serving the coverage area, depending on the context in which the term is used. In implementations of wireless network 100 herein, base stations 105 may be associated with a same operator or different operators (e.g., wireless network 100 may include a plurality of operator wireless networks). Additionally, in implementations of wireless network 100 herein, base station 105 may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In some other examples, each base station 105 and UE 115 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the implementation illustrated in FIG. 1 are examples of mobile smart phone-type devices accessing wireless network 100. A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 100 may occur using wired or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f. Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of implementations supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD communications or low-latency FDD communications, such as in a vehicle-to-vehicle (V2V) mesh network between UEs 115i-115k communicating with macro base station 105e. Additionally, V2V mesh network may include or correspond to a vehicle-to-everything (V2X) network between UEs 115i-115k and one or more other devices, such as UEs 115x, 115y.

Base stations 105 may communicate with a core network 130 and with one another. For example, base stations 105 may interface with the core network 130 through backhaul links 132 (e.g., via an S1, N2, N3, or other interface). Base stations 105 may communicate with one another over backhaul links (e.g., via an X2, Xn, or other interface) either directly (e.g., directly between base stations 105) or indirectly (e.g., via core network 130).

Core network 130 may provide user authentication, access authorization, tracking, Internet Protocol (IP) connectivity, and other access, routing, or mobility functions. The core network 130 may be an evolved packet core (EPC), which may include at least one mobility management entity (MME), at least one serving gateway (S-GW), and at least one packet data network (PDN) gateway (P-GW). The MME may manage non-access stratum (e.g., control plane) functions such as mobility, authentication, and bearer management for UEs 115 served by base stations 105 associated with the EPC. User IP packets may be transferred through the S-GW, which itself may be connected to the P-GW. The P-GW may provide IP address allocation as well as other functions. The P-GW may be connected to the network operators IP services. The operators IP services may include access to the Internet, Intranet(s), an IP multimedia subsystem (IMS), or a packet-switched (PS) streaming service.

In some implementations, core network 130 includes or is coupled to a Location Management Function (LMF) 131, which is an entity in the 5G Core Network (5GC) supporting various functionality, such as managing support for different location services for one or more UEs. For example, the LMF 131 may include one or more servers, such as multiple distributed servers. Base stations 105 may forward location messages to the LMF 131 and may communicate with the LMF via a NR Positioning Protocol A (NRPPa).

The LMF 131 is configured to control the positioning parameters for UEs 115 and the LMF 131 can provide information to the base stations 105 and UE 115 so that action can be taken at UE 115. In some implementations, UE 115 and base station 105 are configured to communicate with the LMF 131 via an Access and Mobility Management Function (AMF).

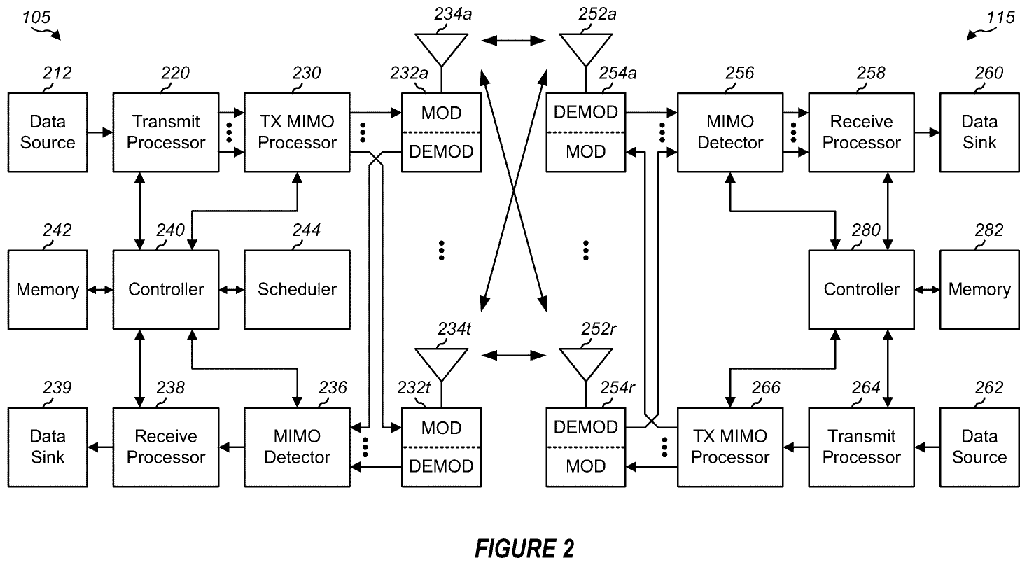

FIG. 2 is a block diagram illustrating examples of base station 105 and UE 115 according to one or more aspects. Base station 105 and UE 115 may be any of the base stations and one of the UEs in FIG. 1. For a restricted association scenario (as mentioned above), base station 105 may be small cell base station 105f in FIG. 1, and UE 115 may be UE 115c or 115d operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At base station 105, transmit processor 220 may receive data from data source 212 and control information from controller 240, such as a processor. The control information may be for a physical broadcast channel (PBCH), a physical control format indicator channel (PCFICH), a physical hybrid-ARQ (automatic repeat request) indicator channel (PHICH), a physical downlink control channel (PDCCH), an enhanced physical downlink control channel (EPDCCH), an MTC physical downlink control channel (MPDCCH), etc. The data may be for a physical downlink shared channel (PDSCH), etc. Additionally, transmit processor 220 may process (e.g., encode and symbol map) the data and control information to obtain data symbols and control symbols, respectively. Transmit processor 220 may also generate reference symbols, e.g., for the primary synchronization signal (PSS) and secondary synchronization signal (SSS), and cell-specific reference signal. Transmit (TX) MIMO processor 230 may perform spatial processing (e.g., precoding) on the data symbols, the control symbols, or the reference symbols, if applicable, and may provide output symbol streams to modulators (MODs) 232a through 232t. For example, spatial processing performed on the data symbols, the control symbols, or the reference symbols may include precoding. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via antennas 234a through 234t, respectively.

At UE 115, antennas 252a through 252r may receive the downlink signals from base station 105 and may provide received signals to demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for UE 115 to data sink 260, and provide decoded control information to controller 280, such as a processor.

On the uplink, at UE 115, transmit processor 264 may receive and process data (e.g., for a physical uplink shared channel (PUSCH)) from data source 262 and control information (e.g., for a physical uplink control channel (PUCCH)) from controller 280. Additionally, transmit processor 264 may also generate reference symbols for a reference signal. The symbols from transmit processor 264 may be precoded by TX MIMO processor 266 if applicable, further processed by modulators 254a through 254r (e.g., for SC-FDM, etc.), and transmitted to base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Receive processor 238 may provide the decoded data to data sink 239 and the decoded control information to controller 240.

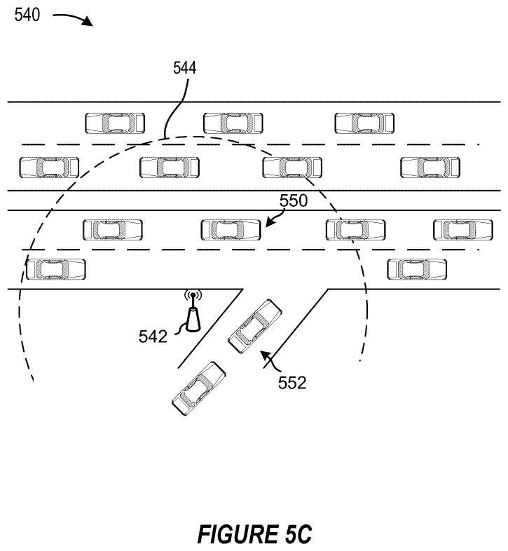

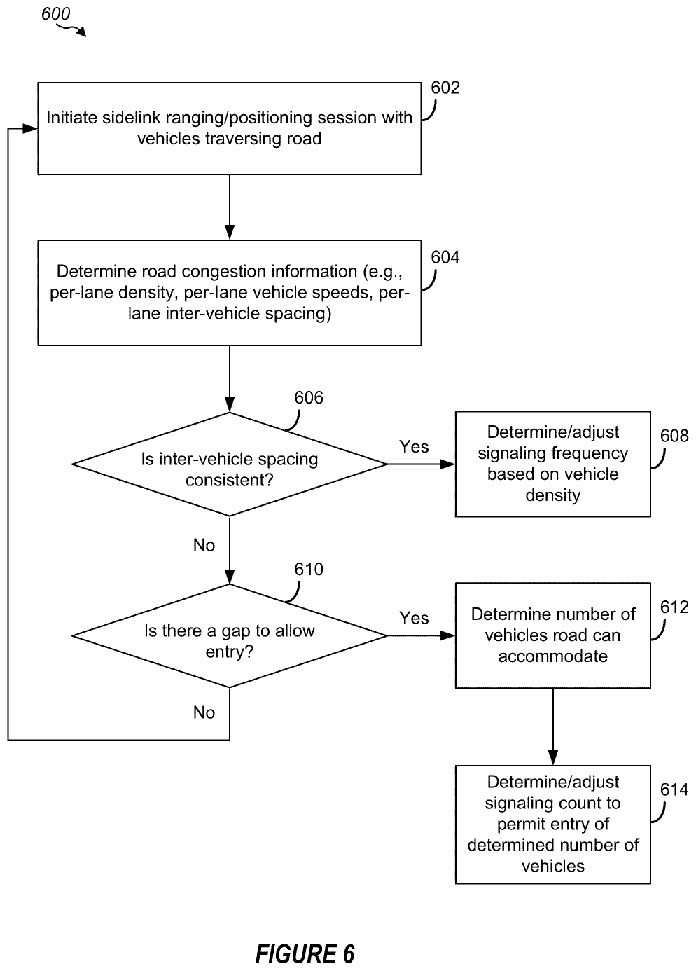

Controllers 240 and 280 may direct the operation at base station 105 and UE 115, respectively. Controller 240 or other processors and modules at base station 105 or controller 280 or other processors and modules at UE 115 may perform or direct the execution of various processes for the techniques described herein, such as to perform or direct the execution illustrated in or described with reference to FIGS. 6-7, or other processes for the techniques described herein. Memories 242 and 282 may store data and program codes for base station 105 and UE 115, respectively. Scheduler 244 may schedule UEs for data transmission on the downlink or the uplink.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen-before-talk or listen-before-transmitting (LBT) procedure such as a clear channel assessment (CCA) prior to communicating in order to determine whether the shared channel is available. In some implementations, a CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel or the acknowledge/negative-acknowledge (ACK/NACK) feedback for its own transmitted packets as a proxy for collisions.

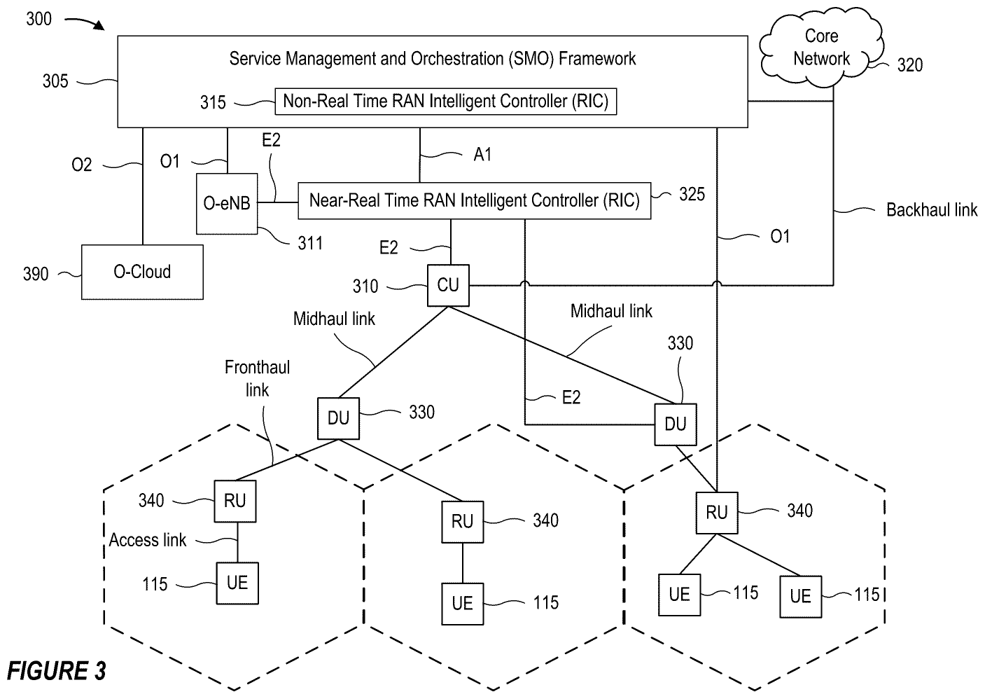

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). Core network 320 may include or correspond to core network 130. A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 115 via one or more radio frequency (RF) access links. In some implementations, the UE 115 may be simultaneously served by multiple RUs 340.

Each of the units, i.e., the CUs 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RUs 340 can be implemented to handle over the air (OTA) communication with one or more UEs 115. In some implementations, real-time and non-real-time aspects of control and user plane communication with the RUs 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As described herein, a node (which may be referred to as a node, a network node, a network entity, or a wireless node) may include, be, or be included in (e.g., be a component of) a base station (e.g., any base station described herein), a transmission and reception point (TRP), a UE (e.g., any UE described herein), a network controller, an apparatus, a device, a computing system, an integrated access and backhauling (IAB) node, a distributed unit (DU), a central unit (CU), a remote unit (RU), a core network, a LFM, a server, and/or a another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first one or more components, a first processing entity, or the like configured to receive the information; and the second network node may refer to a second UE, a second base station, a second apparatus, a second device, a second computing system, a second one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

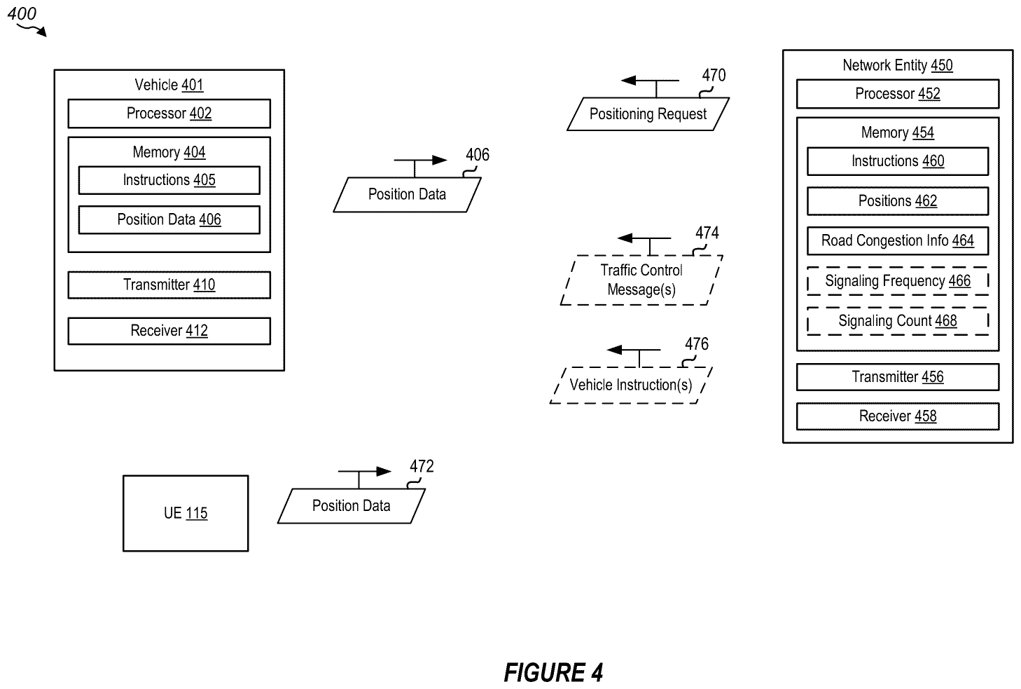

FIG. 4 is a block diagram of an example wireless communications system 400 that supports sidelink positioning-based traffic control according to one or more aspects. In some examples, wireless communications system 400 may implement aspects of wireless network 100. Wireless communications system 400 includes UE 115 and base station 105. In some implementations, vehicle 401 may include or correspond to UEs 115e, 115i, 115j, 115k of FIG. 1. In some implementations, vehicle 401 and UE 115 may be individually or collectively referred to as a vehicle system. Although one UE 115, one vehicle 401, and one network entity 450 are illustrated in FIG. 4, in some other implementations, wireless communications system 400 may generally include multiple UEs 115, multiple vehicles 401, multiple network entities 450, or a combination thereof.

In some implementations, wireless communications system 400 includes a vehicle to everything (V2X) wireless communication system. V2X is a communication system in which information is passed between a vehicle and other entities within the wireless communication network that provides the V2X services. The V2X services may include services for Vehicle-to-Vehicle (V2V), Vehicle-to-Pedestrian (V2P), Vehicle-to-Infrastructure (V2I), and Vehicle-to-Network (V2N). One or more V2X standards aim to develop or support an Advanced Driver Assistance System (ADAS), which assist a driver with critical decisions, such as lane changes, speed changes, overtaking speeds, etc. Low latency communications may be used in V2X and, are therefore suitable for precise positioning. For example, positioning techniques, such as time of arrival (TOA), time difference of arrival (TDOA) or observed time difference of arrival (OTDOA), or any other cellular positioning technique, may be enhanced using assistance from V2X.

In general, there may be at least two modes of operation for V2X services, as defined in Third Generation Partnership Project (3GPP) TS 23.285. One mode of operation uses direct wireless communications between V2X entities when the V2X entities are within range of each other. The other mode of operation uses network based wireless communication between entities. The two modes of operation may be combined or other modes of operation may be used if desired.

The wireless communication of a V2X wireless communication system may be over Proximity-based Services (ProSe) Direction Communication (PC5) reference point as defined in 3GPP TS 23.303, and may use wireless communications under Institute of Electrical and Electronics Engineers (IEEE) 1609, Wireless Access in Vehicular Environments (WAVE), Intelligent Transport Systems (ITS), and IEEE 802.11p, on the ITS band of 5.9 GHz, or other wireless connections directly between entities. Such wireless communications may include or be referred to as sidelink communications.

In some implementations, UE 115, network entity 450, and vehicle 401 may be positioned within a common geographic area. In other implementations, UE 115 may be in a different geographic area than network entity 450 and vehicle 401. In some implementations, UE 115, vehicle 401, or both, are mobile devices. Network entity 450 may include a base station, such as base station 105 of FIGS. 1-3, an access point (AP), a roadside unit (RSU), another UE or vehicle, or part of a core network, such as core network 130 of FIG. 1. Network entity 450 may be stationary or mobile. In some implementations, network entity 450 includes or is integrated with a traffic control device, such as a traffic light, an on-ramp access control device, a digital road sign, or another type of traffic control device. In some other implementations, network entity 450 is communicatively coupled to a traffic control device and communicates with the traffic control device to control the traffic control device (e.g., via providing instructions), to provide network access to the traffic control device, or a combination thereof.

Vehicle 401 may include a device, such as a mobile device or a vehicle. For example, vehicle 401 may include or correspond to UEs 115e, 115i, 115j, 115k of FIG. 1. As illustrative examples, vehicle 401 may include a self-driving car or assisted-driving car, a UAV or drone aircraft, such as drone 115e of FIG. 1, or any other type of autonomous or semi-autonomous land craft, watercraft, aircraft, or combination thereof. Although examples are described herein in the context of an autonomous or semi-autonomous car, such examples are illustrative and are not intended to limit vehicle 401 to any particular type of vehicle. Additionally or alternatively, although referred to herein as being a vehicle, the components of vehicle 401 may be included in or integrated within an onboard unit (OBU) of a vehicle. Vehicle 401 may include a variety of components (such as structural, hardware components) used for carrying out one or more functions described herein. For example, these components may include one or more processors 402 (hereinafter referred to collectively as “processor 402”), one or more memory devices 404 (hereinafter referred to collectively as “memory 404”), one or more transmitters 410 (hereinafter referred to collectively as “transmitter 410”), and one or more receivers 412 (hereinafter referred to collectively as “receiver 412”). In some implementations, vehicle 401 may include an interface (e.g., a communication interface) that includes transmitter 410, receiver 412, or a combination thereof. Processor 402 may be configured to execute instructions 405 stored in memory 404 to perform the operations described herein. In some implementations, processor 402 includes or corresponds to one or more of receive processor 258, transmit processor 264, and controller 280 of FIG. 2, and memory 404 includes or corresponds to memory 282 of FIG. 2.

Memory 404 includes or is configured to store instructions 405 and position data 406. Position data 406 may indicate a position or location of vehicle 401, such as based on an external position measurement (e.g., GPS coordinates, GNSS coordinates, etc.) or based on relative positioning performed with other devices of wireless communications system 400, such as such as positioning based on time of arrival (TOA), time difference of arrival (TDOA) or observed time difference of arrival (OTDOA), or any other cellular positioning technique, which may be enhanced using assistance from V2X. Although referred to as position data 406, in some implementations, position data 406 may also include or be replaced with ranging data that indicates a range of vehicle 401 with respect to network entity 450 (or another known location).

Transmitter 410 is configured to transmit reference signals, control information and data to one or more other devices, and receiver 412 is configured to receive references signals, synchronization signals, control information and data from one or more other devices. For example, transmitter 410 may transmit signaling, control information and data to, and receiver 412 may receive signaling, control information and data from, network entity 450, UE 115, or another vehicle 401. In some implementations, transmitter 410 and receiver 412 may be integrated in one or more transceivers. Additionally, or alternatively, transmitter 410 or receiver 412 may include or correspond to one or more components of UE 115 described with reference to FIG. 2.

In some implementations, vehicle 401 may include one or more antenna arrays. The one or more antenna arrays may be coupled to transmitter 410, receiver 412, or a communication interface. An antenna array may include multiple antenna elements configured to perform wireless communications with other devices, such as with network entity 450 or UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams. Alternatively, one or more sets of antenna elements of the antenna array may be configured to concurrently generate multiple beams, for example using multiple RF chains of vehicle 401. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Vehicle 401 may include one or more components as described herein with reference to UE 115 of FIGS. 1-3. In some implementations, vehicle 401 is a 5G-capable vehicle, a 6G-capable vehicle, or a combination thereof.

UE 115 may include a device, such as a mobile device or a stationary device. In some implementations, UE 115 is a device that is configured to communicate with vehicle 401, network entity 450, or both. In some implementations, UE 115 is configured to control or partially control operations of vehicle 401. Alternatively, UE 115 may be associated with a pedestrian or another type of device other than a vehicle. UE 115 may include a variety of components (such as structural, hardware components) used for carrying out one or more functions described herein. For example, these components may include one or more processors, one or more memory devices, one or more transmitters, one or more receivers, and optionally an antenna array, as described above with reference to vehicle 401. In some implementations, UE 115 may include an interface (e.g., a communication interface) that includes a transmitter, a receiver, or a combination thereof. The one or more processors may be configured to execute instructions stored in the one or more memory devices to perform the operations described herein. In some implementations, the one or more processors include or correspond to one or more of receive processor 258, transmit processor 264, and controller 280 of FIG. 2, and the one or more memory devices include or correspond to memory 282 of FIG. 2.

UE 115 may include one or more components as described herein with reference to UE 115 of FIGS. 1-3. In some implementations, UE 115 is a 5G-capable UE, a 6G-capable UE, or a combination thereof.

Network entity 450 may include a device, such as a base station, a roadside unit (RSU), a node, a part of a core network, a server, or another network device. Network entity 450 may be a mobile device or a stationary device. Network entity 450 may include a variety of components (such as structural, hardware components) used for carrying out one or more functions described herein. For example, these components may include one or more processors 452 (hereinafter referred to collectively as “processor 452”), one or more memory devices 454 (hereinafter referred to collectively as “memory 454”), one or more transmitters 456 (hereinafter referred to collectively as “transmitter 456”), and one or more receivers 458 (hereinafter referred to collectively as “receiver 458”). In some implementations, network entity 450 may include an interface (e.g., a communication interface) that includes transmitter 456, receiver 458, or a combination thereof. As described above, in some implementations, network entity 450 includes or is integrated within a traffic control device, such as a stop light, an on-ramp access control device, another type of RSU, etc. In some other implementations, network entity 450 is communicatively coupled to, and configured to communicate with to control, such a traffic control device.

Processor 452 may be configured to execute instructions 460 stored in memory 454 to perform the operations described herein. In some implementations, processor 452 includes or corresponds to one or more of receive processor 238, transmit processor 220, and controller 240, and memory 454 includes or corresponds to memory 242 of FIG. 2. Memory 454 includes or is configured to store instructions 460, positions 462, road congestion information 464, and in some implementations, signaling frequency 466 or signaling count 468. Positions 462 may indicate the locations (e.g., positions) of one or more devices within wireless communications system 400, such as one or more vehicles (e.g., vehicle 401), one or more UEs (e.g., UE 115), or a combination thereof. Network entity 450 may be configured to determine positions 462 of various devices based on position data received from the various devices, as further described below. Road congestions information 464 indicates congestion of a road (or a portion thereof) that network entity 450 (or a connected traffic control device) is configured to monitor and provide traffic control information or instructions. In some implementations, road congestion information 464 includes vehicle density of one or more vehicles along a portion of the road, vehicle speeds of the one or more vehicles, inter-vehicle spacing between the one or more vehicles, or a combination thereof. Such information may be provided on a per-direction basis, a per-lane basis, a per-road basis, or in any other manner that supports the functionality described herein. Signaling frequency 466 indicates a frequency with which network entity 450 may provide traffic control signaling, such as via control of displayable indicators or transmission of wireless messages to other devices. Signaling count 468 indicates a count of vehicles (or other devices) for which network entity 450 may provide traffic control signaling, such as via control of displayable indicators or transmission of wireless messages to the vehicles.

Transmitter 456 is configured to transmit reference signals, control information and data to one or more other devices, and receiver 458 is configured to receive references signals, synchronization signals, control information and data from one or more other devices. For example, transmitter 456 may transmit signaling, control information and data to, and receiver 458 may receive signaling, control information and data from, vehicle 401, UE 115, or another network entity 450. In some implementations, transmitter 456 and receiver 458 may be integrated in one or more transceivers. Additionally, or alternatively, transmitter 456 or receiver 458 may include or correspond to one or more components of base station 105 described with reference to FIG. 2.

In some implementations, network entity 450 may include one or more antenna arrays. The one or more antenna arrays may be coupled to transmitter 456, receiver 458, or a communication interface. An antenna array may include multiple antenna elements configured to perform wireless communications with other devices, such as with vehicle 401 or UE 115. In some implementations, the antenna array may be configured to perform wireless communications using different beams, also referred to as antenna beams. The beams may include TX beams and RX beams. To illustrate, the antenna array may include multiple independent sets (or subsets) of antenna elements (or multiple individual antenna arrays), and each set of antenna elements of the antenna array may be configured to communicate using a different respective beam that may have a different respective direction than the other beams. For example, a first set of antenna elements of the antenna array may be configured to communicate via a first beam having a first direction, and a second set of antenna elements of the antenna array may be configured to communicate via a second beam having a second direction. In other implementations, the antenna array may be configured to communicate via more than two beams.

Alternatively, one or more sets of antenna elements of the antenna array may be configured to concurrently generate multiple beams, for example using multiple RF chains of network entity 450. Each individual set (or subset) of antenna elements may include multiple antenna elements, such as two antenna elements, four antenna elements, ten antenna elements, twenty antenna elements, or any other number of antenna elements greater than two. Although described as an antenna array, in other implementations, the antenna array may include or correspond to multiple antenna panels, and each antenna panel may be configured to communicate using a different respective beam.

Network entity 450 may include one or more components as described herein with reference to base station 105 of FIGS. 1-3. In some implementations, network entity 450 is a 5G-capable network entity, a 6G-capable network entity, or a combination thereof.

In some implementations, wireless communications system 400 implements a 5G NR network. For example, wireless communications system 400 may include multiple 5G-capable UEs 115, multiple 5G-capable vehicles 401, or multiple 5G capable network entities 450, such as UEs, vehicles, and network entities configured to operate in accordance with a 5G NR network protocol such as that defined by the 3GPP. In some other implementations, wireless communications system 400 implements a 6G network.

During operation of wireless communications system 400, network entity 450 may receiving position data associated with one or more vehicles based on positioning request 470. Such positioning data may be received from vehicles that are travelling along a road that is monitored or assigned to network entity 450, vehicles that are on an on-ramp or other entrance to the road, UEs of pedestrians, UEs or RSUs that are located in fixed locations on or near the road, or any other types of vehicles or UEs. For example, network entity 450 may receive position data 406 from vehicle 401. As described above, position data 406 may indicate a position or location of vehicle 401, such as based on an external position measurement (e.g., GPS coordinates, GNSS coordinates, etc.) or based on relative positioning performed with other devices of wireless communications system 400. Although referred to as position data 406, position data 406 may include one or more types of positioning or ranging data. Network entity 450 may also receive position data 472 from UE 115 (or from other vehicles or other UEs). Position data 472 may indicate a position or location of UE 115, such as based on an external position measurement (e.g., GPS coordinates, GNSS coordinates, etc.) or based on relative positioning performed with other devices of wireless communications system 400, similar to as described above for position data 406. Network entity 450 may receive position data (e.g., position data 406, 472) from other devices via one or more sidelink (SL) communications, which may be in accordance with a PC5 communication standard. In some implementations, position data 406, 472 is included in one or more basic safety messages (BSMs), one or more pedestrian safety messages (PSMs), one or more cooperative awareness messages (CAMs), another type of positioning or ranging message, or a combination thereof.

To trigger receipt of position data 406 and 472, network entity 450 may transmit positioning request 470 to one or more devices. In some implementations, network entity 450 may transmit positioning request 470 via one or more sidelink communications to a group of vehicles that are located within a particular range from a location of network entity 450. For example, network entity 450 may use a “connection-less” (e.g., distance-based) groupcast message that specifies a particular range to transmit positioning request 470, and all sidelink positioning capable vehicles and UEs (e.g., vehicle 401 and UE 115) that are located within the particular range from network entity 450 may receive and respond to positioning request 470. Thus, network entity 450 may target a more restricted region than just an area within a communication range of network entity 450. The connection-less groupcasting may be particularly useful to enable network entity 450 to target a more restricted region, such as complicated road topologies with multiple on-ramps or off-ramps, or multiple city blocks. In some other implementations, network entity 450 may broadcast positioning request 470 via one or more sidelink communications, such that all vehicles and UEs within a communication range of network entity 450 may receive and respond to positioning request 470. Network entity 450 may transmit (e.g., either via broadcasting or groupcasting) positioning request 470 periodically. In some implementations, a transmission frequency of positioning request 470 is based on a time of day, a day of a week, a month of a year, or a combination thereof. For example, the transmission frequency of positioning request 470 may be higher during time periods in which higher traffic density is expected (e.g., rush hour) or lower during time periods in which lower traffic density is expected (e.g., after work, late at night, or on holidays). Additionally or alternatively, the transmission frequency of positioning request 470 may be based on a vehicle density along a portion of a road that is covered by network entity 450. For example, during times in which vehicle is equal to or greater than a threshold, network entity 450 may increase the transmission frequency of positioning request 470, allowing for more accurate determinations of road congestion during congested times.

After receiving position data 406 and 472, network entity 450 may control the traffic control device (e.g., either integrated with or communicatively coupled to network entity 450) based on road congestion information 464. Road congestion information 464 may indicate vehicle density of one or more vehicles along a portion of the road, vehicle speeds of the one or more vehicles, inter-vehicle spacing between the one or more vehicles, other vehicle congestion or vehicle density information (or information derived therefrom, or a combination thereof. Network entity 450 may determine road congestion information 464 based on position data 406, 472. To illustrate, network entity 450 may determine positions 462 of one or more vehicles or UEs (e.g., vehicle 401 and UE 115) along a portion of the road based on position data 406, 471, speeds of the one or more vehicles, or a combination thereof, and network entity 450 may determine road congestion information 464 based on positions 462, the speeds of the one or more vehicles, optionally map data associated with the road, other information, or a combination thereof. For example, position data 406 may indicate one or more absolute positions of vehicle 401 (e.g., at one or more different times), a heading of vehicle 401, a speed or velocity of vehicle 401, other information, or a combination thereof, position data 472 may indicate similar information related to UE 115, and the positions extracted from position data 406, 472 may be used as positions 462. Alternatively, position data 406, 472 may include information from which network entity 450 may calculate, estimate, or otherwise determine positions 462 with respect to vehicle 401 and UE 115. Network entity 450 may extract (e.g., from position data 406, 472) or determine vehicle speeds for use in combination with positions 462 to determine aspects of road congestion information 464, such as inter-vehicle speeds or inter-vehicle spacing, and vehicle density may be determined based on a number of responses to positioning request 470 and a threshold (or a number of responses within a particular area of a map, such as overlapping the portion of the road, and a threshold). Road congestion information 464 may indicate, or be used analyzed by network entity 450 to determine, one or more gaps into which additional vehicles may enter the road without violating one or more safety rules, such as inter-vehicle spacing rules, vehicle density rules, vehicle speed rules, etc. In some implementations, road congestion information 464 may be updated based on receipt of additional positioning information (e.g., due to periodic transmission of positioning request 470). For example, network entity 450 may receive second position data from vehicle 401, and network entity 450 may update road congestion information 464 based on the second position data (and additional position data from other vehicles or UEs).

After determining road congestion information 464, network entity 450 may control the traffic control device based on road congestion information 464. As described above, the traffic control device may be integrated within network entity 450, and thus may be controlled by processor 452, or the traffic control device may be communicatively coupled to network entity 450, and thus network entity 450 may be configured to control the traffic control device via communicating (e.g., providing messages, instructions, etc.) with the traffic control device. In some implementations, controlling the traffic control device includes setting or adjusting signaling frequency 466 based on road congestion information 464. Signaling frequency 466 may indicate a frequency with which the traffic control device signals to additional vehicles that are awaiting entry to the road that they are permitted to enter the road, such as from an on-ramp. For example, signaling frequency 466 may be a frequency with which a green light, a digital display of the word “Go” or “Enter,” or another visual indicator, is displayed or otherwise provided by the traffic control device (e.g., the traffic control device may display a visual indicator according to signaling frequency 466). As another example, signaling frequency 466 may be a frequency with which the traffic control device transmits one or more traffic control messages (hereinafter “traffic control messages 474”) to one or more additional vehicles, such as vehicles awaiting entrance to the road on an on-ramp. Traffic control messages 474 may indicate permission to enter the road to the recipient vehicles. For example, traffic control messages 474 may include V2X signaling to one or more automated or semi-automated vehicles that may not be equipped with a camera or other hardware for detecting a visual indicator.

As an example of controlling signaling frequency 466, network entity 450 may increase signaling frequency 466 (or set signaling frequency 466 to a relatively large initial value) based on road congestion information 464 indicating a substantially consistent inter-vehicle spacing between vehicles along the road and a decrease in vehicle density along the road from a previous vehicle density value (or an initial vehicle density value that fails to satisfy a threshold). As another example, network entity 450 may decrease signaling frequency 466 (or set signaling frequency 466 to a relatively small initial value) based on road congestion information 464 indicating a substantially consistent inter-vehicle spacing between the vehicles along the road and an increase in vehicle density along the road from a previous vehicle density value (or an initial vehicle density value that satisfies a threshold). If road congestion information 464 does not indicate a substantially consistent inter-vehicle spacing between vehicles along the road, network entity 450 may refrain from adjusting signaling frequency 466, or network entity 450 may set signaling frequency 466 to a default value, and optionally network entity 450 may determine whether to permit a particular number of additional vehicles to enter the road if any gaps are identified. Alternatively, network entity 450 may set signaling frequency 466 based on the vehicle density or other information indicated by road congestion information 464, regardless of whether the inter-vehicle spacing is substantially consistent. Based on signaling frequency 466 being set or adjusted, the traffic control device may display visual indicator(s) or transmit traffic control messages 474 according to signaling frequency 466. Although the above-described examples have been provided in the context of the traffic control device being configured to control admittance of additional vehicles to a road (e.g., the traffic control device being an on-ramp light or device), in other implementations, similar operations may be performed to adjust signaling frequency 466 for other types of traffic control devices. As a non-limiting example, the traffic control device may be a stop light, and network entity 450 may set or adjust signaling frequency 466 (e.g., a frequency of cycling between green and red lights by the stoplight) based on road congestion information 464.

In some implementations, controlling the traffic control device includes causing the traffic control device to indicate permission for a particular number of additional vehicles to enter the road based on road congestion information 464. For example, network entity 450 may determine a particular number of additional vehicles to permit to enter the road based on inter-vehicle spacing, vehicle speeds, or both, indicated by signaling frequency 466. To illustrate, network entity 450 may identify a gap in the traffic based on the inter-vehicle spacing, and upon determining any modifications to the gap based on the speed of the vehicles on either side of the gap, network entity 450 may determine a count of additional vehicles that may safely enter the road and travel within the gap. To further illustrate, if network entity 450 determines that the inter-vehicle spacing between two consecutive vehicles in the same lane forms a gap that is greater in size than the size of two additional vehicles, and that the speeds of the two consecutive vehicles are substantially similar (or that the speed of the trailing vehicle is not significantly greater than the leading vehicle such as to decrease the size of the gap as the two consecutive cars travel), then network entity 450 may determine to permit a count of two additional vehicles to enter the road. To permit the additional vehicles to enter the road, network entity 450 may provide signaling count 468 to the traffic control device, where signaling count 468 is the same as the count of additional vehicles. Stated another way, network entity 450 may cause the traffic control device to indicate permission for the particular number of additional vehicles to enter the road by causing the traffic control device to provide signaling according to signaling count 468. In some implementations, network entity 450 causes the traffic control device to display a visual indicator associated with permission to enter the road for a time period, or to display visual indicators a particular number of times, that corresponds to signaling count 468. To further illustrate, if signaling count 468 is two, the traffic control device may display a green light to the first two additional cars on the on-ramp to cause the first two additional cars to enter the road. In some other implementations, network entity 450 causes the traffic control device to transmit traffic control messages 474 that indicate permission to enter the road to a number of additional vehicles that is equal to signaling count 468. Although described in the context of an on-ramp light, in other implementations, other types of traffic control devices may be controlled based on signaling count 468. As a non-limiting example, network entity 450 may cause a stop light to display a turn signal for a time period, or a number of times, that corresponds to signaling count 468.

In addition or in the alternative to controlling the traffic control device using signaling frequency 466 or signaling count 468, network entity 450 may provide other control functionality, such as speed harmonization or group starting, by causing the traffic control device to transmit instructions to vehicles or other UEs. For example, network entity 450 may determine a vehicle instruction associated with a first vehicle traveling along the road based on road congestion information 464, and network entity 450 may transmit (or cause the traffic control device to transmit) the vehicle instruction to the first vehicle. Non-limiting examples of vehicle instructions provided by network entity 450 include instructions that indicate a particular inter-vehicle separation to be maintained between the first vehicle and any adjacent vehicles, a particular speed to be maintained by the first vehicle, one or more actions for traversing an intersection of the road, other actions to be performed or parameters to be applied, or a combination thereof. To illustrate, network entity 450 may use RSU-based sidelink positioning to provide speed harmonization functionality to automated vehicles by determining target vehicle speeds and inter-vehicle separation based on target fuel efficiency, target vehicle density, target transit times, or the like, in order to enable automated vehicles to minimize stoppages, decrease traversal time, improve fuel efficiency, or a combination thereof. As another example, to provide group start functionality, network entity 450 may include or communicate with an intersection-deployed RSU that uses sidelink positioning to determine per-lane vehicle density and separation to provide instructions to groups of vehicles to efficiently start and traverse the intersection.

As described with reference to FIG. 4, the present disclosure provides techniques for sidelink positioning-based traffic control. The techniques provide for control, by network entity 450, of a traffic control device (e.g., that is integrated in or communicatively coupled to network entity 450) based on position data 406 and 472 received from vehicle 401 and UE 115, respectively, via sidelink communications. By providing for position-aware traffic control using sidelink communications, “smart highway” devices such as on-ramp devices or traffic lights may be deployed with increased efficiently and reduced cost as compared to conventional traffic control devices that require expensive and difficult to install and repair components such as sensors buried under roads, or cameras or other components that can be damaged or obscured by weather or lighting conditions. Additionally, wireless communications system 400 of FIG. 4 provides improved traffic control (e.g., based on real-time positioning and ranging data communicated via sidelink communications), a reduction in traffic accidents due to improper traffic control, or a combination thereof.

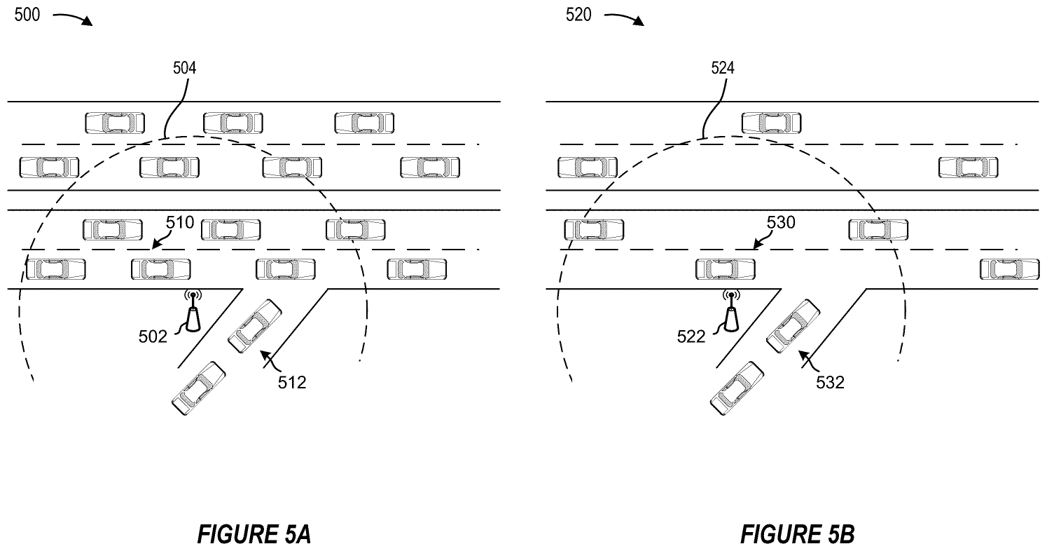

FIGS. 5A-C are diagrams of examples of sidelink positioning-based traffic control according to one or more aspects. In the examples shown in FIGS. 5A-C, a traffic control device is integrated within an RSU and configured to perform sidelink positioning to determine road congestion information and to control a signaling frequency or a signaling count based on the road congestion information. The signaling frequency or the signaling count may be used to permit additional vehicle(s) to enter a road (e.g., a highway or freeway) from an on-ramp, as shown in FIGS. 5A-C. In other implementations, the techniques described herein may be used by different types of traffic control devices or network entities or in different traffic control contexts.

FIG. 5A depicts a first example 500 in which the road is congested. First example 500 includes an RSU 502 that is adjacent to the on-ramp of the road. In order to determine road congestion information, RSU 502 may utilize sidelink communication(s) to transmit a positioning request to vehicles within a region 504, which may be a coverage area (e.g., for broadcast transmissions) or a selected range (e.g., for distance-based group casting).

Vehicles 510 within region 504 may receive the positioning request and may respond by transmitting position data or ranging data via respective sidelink communications. In first example 500 shown in FIG. 5A, vehicles 510 within region 504 include seven vehicles: five vehicles traveling in the lanes accessed by the on-ramp, and two vehicles traveling in the opposite lanes. Additional vehicles 512 are stopped on the on-ramp and, while waiting for permission to enter the road, additional vehicles 512 may receive the positioning request and respond by sending respective position data via sidelink communications to RSU 502. RSU 502 may receive the position data and determine road congestion information, as described above with reference to FIG. 4. In some implementations, RSU 502 may be able to identify that two vehicles are traveling in the opposite lanes and discard the associated position data, such as based on distance, position, inter-vehicle spacing, etc. In first example 500, RSU 502 may determine that there is a substantially consistent inter-vehicle spacing and that the vehicle density satisfies a threshold (or has increased from a previous determination). Based on this determination, RSU 502 may determine to decrease the signaling frequency (or set the signaling frequency to a small initial value), such that signaling to additional vehicles 512 to indicate permission to enter the road is provided conservatively (e.g., infrequently).

FIG. 5B depicts a second example 520 in which the road is less congested. Second example 520 includes an RSU 522 that is adjacent to the on-ramp of the road. In order to determine road congestion information, RSU 522 may utilize sidelink communication(s) to transmit a positioning request to vehicles within a region 524, which may be a coverage area (e.g., for broadcast transmissions) or a selected range (e.g., for distance-based group casting). Vehicles 530 within region 524 may receive the positioning request and may respond by transmitting position data or ranging data via respective sidelink communications. In second example 520 shown in FIG. 5B, the road is less congested than in FIG. 5A, and vehicles 530 within region 524 include three vehicles traveling in the lanes accessed by the on-ramp and no vehicles traveling in the opposite lanes.

Additional vehicles 532 are stopped on the on-ramp and, while waiting for permission to enter the road, additional vehicles 532 may receive the positioning request and respond by sending respective position data via sidelink communications to RSU 522. RSU 522 may receive the position data and determine road congestion information, as described above with reference to FIG. 4. In second example 520, RSU 522 may determine that there is a substantially consistent inter-vehicle spacing and that the vehicle density does not satisfy a threshold (or has decreased from a previous determination). Based on this determination, RSU 522 may determine to increase the signaling frequency (or set the signaling frequency to a large initial value), such that signaling to additional vehicles 532 to indicate permission to enter the road is provided more aggressively (e.g., frequently) than with respect to FIG. 5A. As such, additional vehicles 532 may enter the road faster in FIG. 5B than addition vehicles 512 in FIG. 5A.

FIG. 5C depicts a third example 540 in which a gap in vehicle congestion permits entrance of a particular number of vehicles. Third example 540 includes an RSU 542 that is adjacent to the on-ramp of the road. In order to determine road congestion information, RSU 542 may utilize sidelink communication(s) to transmit a positioning request to vehicles within a region 544, which may be a coverage area (e.g., for broadcast transmissions) or a selected range (e.g., for distance-based group casting). Vehicles 550 within region 544 may receive the positioning request and may respond by transmitting position data or ranging data via respective sidelink communications. In third example 540 shown in FIG. 5C, vehicles 550 within region 544 include sis vehicles: four vehicles traveling in the lanes accessed by the on-ramp, and two vehicles traveling in the opposite lanes. Additional vehicles 552 are stopped on the on-ramp and, while waiting for permission to enter the road, additional vehicles 552 may receive the positioning request and respond by sending respective position data via sidelink communications to RSU 542.

RSU 542 may receive the position data and determine road congestion information, as described above with reference to FIG. 4. In some implementations, RSU 542 may be able to identify that two vehicles are traveling in the opposite lanes and discard the associated position data, such as based on distance, position, inter-vehicle spacing, etc.

In third example 540, RSU 542 may determine that there is not a substantially consistent inter-vehicle spacing but that a sufficient gap exists between vehicles to permit entrance of one or more additional vehicles. Based on this determination, RSU 542 may determine the signaling count such that signaling to additional vehicles 552 to indicate permission to enter the road is provided according to the signaling count. For example, RSU 542 may determine that the gap will support two additional vehicles and thus set the signaling count to be two, such that a visual indicator may be displayed (or messaging provided) to enable two of additional vehicles 552 to enter the road.

FIG. 6 is a flow diagram illustrating an example process 600 that supports sidelink positioning-based traffic control according to one or more aspects. Operations of process 600 may be performed by a network entity, such as base station 105 of FIGS. 1-3, network entity 450 of FIG. 4, RSU 502 of FIG. 5A, RSU 522 of FIG. 5B, or RSU 542 of FIG. 5C, another RSU, or another network entity. Example operations of process 600 may enable the network entity to support sidelink positioning-based traffic control and road access control, such as by controlling a traffic control device that is integrated in or communicatively coupled to the network entity.

At block 602, the network entity initiates sidelink ranging or positioning session(s) with vehicles(s) traversing a road. For example, the network entity may send, via broadcasting or distance-based groupcasting via sidelink communication (e.g., PC5 communication), a positioning request to vehicles within a particular distance from the network entity.

Vehicles that receive the positioning request may respond and engage in sidelink positioning sessions with the network entity in which the vehicles provide position data via sidelink communications to the network entity. The position data may be based on GPS coordinates, GNSS coordinates, network-based position data, V2X positioning information, other absolute or relative position data, or a combination thereof. In some implementations, the position data may correspond to periodic measurements, and the periodicity of such measurements may be based on time-of-day (e.g., rush hour), day-of-week, or other temporal conditions, or based on detected conditions, such as a detected vehicle density or congestion.

At block 604, the network entity determines road congestion information based on the position data from the positioning sessions with the vehicles. For example, the road congestion information may include or correspond to road congestion information 464 of FIG. 4, and may be determined as described above with reference to FIG. 4. In some implementations, the road congestion information includes per-lane density (e.g., vehicle density), per-lane vehicle speeds, and per-lane inter-vehicle spacing. In other implementations, the road congestion information may include fewer types of information or additional types of information, in any combination.

At block 606, the network entity determines if the inter-vehicle spacing is substantially consistent. For example, the network entity may determine the spacing between each pair of consecutive vehicles in the same lane for one or more lanes of the road (e.g., one or more lanes associated with travel in a particular direction) based on the per-lane inter-vehicle spacing of the road congestion data, and the network entity may compare the various spacing to determine if the various spacings are the same, or within particular tolerances or ranges (e.g., substantially equal), which signifies the inter-vehicle spacing is substantially consistent. If the inter-vehicle spacing is substantially consistent, process 600 proceeds to block 608, at which the network entity determines or adjusts a signaling frequency of the traffic control device. For example, the signaling frequency may include or correspond to signaling frequency 466 of FIG. 4.

However, if the inter-vehicle spacing is not substantially consistent, process 600 proceeds from block 606 to block 610, where the network entity determines if there is a gap between the vehicles traveling along the road to allow entry by an additional vehicle. For example, the network entity may determine the spacing between each pair of consecutive vehicles in the same lane for one or more lanes of the road (e.g., one or more lanes accessed by an on-ramp) based on the per-lane inter-vehicle spacing of the road congestion data. If the spacing between two consecutive vehicles is large enough to support an additional vehicle, and the vehicle speeds indicate that the size of the gap will not decrease to the point that it no longer supports the additional vehicle before the vehicle can enter the gap safely, the network entity may determine that there is such a gap. If the network entity does not detect such a gap, process 600 returns to block 602 for additional sidelink positioning and recalculation of the road congestion data. Alternatively, if the gap is detected, process 600 proceeds from block 610 to block 612, at which the network entity determines a number of vehicles that the road can accommodate. For example, the network entity may determine the amount of additional vehicles that can safely fit within the gap at its smallest size (e.g., due to the speeds of the vehicles on either side of the gap). At block 614, the network entity adjusts (or sets) a signaling count to permit entry of the determined number of vehicles to the road. For example, the signaling count may include or correspond to signaling count 468 of FIG. 4. To further illustrate, the traffic control device may display a visual indicator (e.g., a green light) to a number of additional vehicles that corresponds to the signaling count.

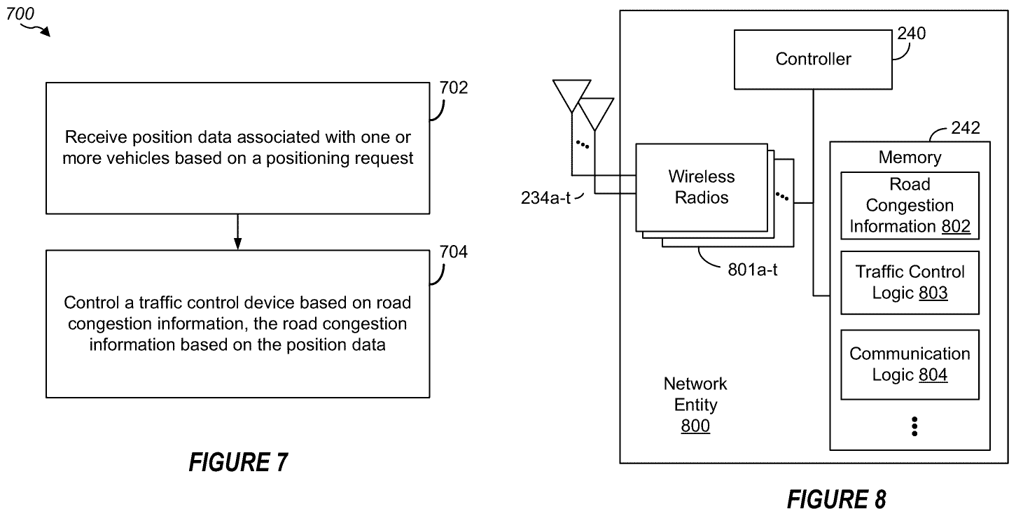

FIG. 7 is a flow diagram illustrating an example process 700 that supports sidelink positioning-based traffic control according to one or more aspects. Operations of process 700 may be performed by a network entity, such as base station 105 of FIGS. 1-3, network entity 450 of FIG. 4, RSU 502 of FIG. 5A, RSU 522 of FIG. 5B, or RSU 542 of FIG. 5C, or a network entity as described with reference to FIG. 8. For example, example operations of process 700 may enable the network entity to support sidelink positioning-based traffic control.

At block 702, the network entity receives position data associated with one or more vehicles based on a positioning request. For example, the position data may include or correspond to position data 406 or position data 472 of FIG. 4, the positioning request may include or correspond to positioning request 470 of FIG. 4, and the one or more vehicles may include or correspond to vehicle 401, UE 115, or a combination thereof, of FIG. 4. In some implementations, the position data is received from the one or more vehicles via one or more sidelink communications. Additionally or alternatively, the position data may be included in one or more BSMs, one or more CAMs, or a combination thereof.

At block 704, the network entity controls a traffic control device based on road congestion information. The road congestion information is based on the position data. For example, the road congestion information may include or correspond to road congestion information 464 of FIG. 4, and the traffic control device may be integrated in or communicatively coupled to network entity 450 of FIG. 4. In some implementations, the road congestion information indicates vehicle density of the one or more vehicles along a portion of a road, vehicle speeds of the one or more vehicles, inter-vehicle spacing between the one or more vehicles, or a combination thereof. In some implementations, the network entity includes, or is integrated with, the traffic control device. In some other implementations, the network entity is distinct from the traffic control device and configured to control the traffic control device via communicating with the traffic control device.

In some implementations, process 700 further includes determining positions of the one or more vehicles along a portion of a road based on the position data, speeds of the one or more vehicles, or a combination thereof. For example, the positions may include or correspond to positions 462 of FIG. 4. In such implementations, process 700 also includes determining the road congestion information based on the positions of the one or more vehicles, the speeds of the one or more vehicles, map data associated with the road, or a combination thereof.

In some implementations, process 700 also includes broadcasting the positioning request via a sidelink communication. For example, positioning request 470 of FIG. 4 may be broadcast via a sidelink communication to any vehicles or other UEs within a communication range of network entity 450. Alternatively, process 700 may further include transmitting the positioning request via a sidelink communication to a group of vehicles that are located within a particular range from a location of the network entity. For example, positioning request 470 of FIG. 4 may be transmitted via a sidelink communication (e.g., a connection-less groupcast) to vehicles or other UEs within a particular range of network entity 450.

In some implementations, controlling the traffic control device includes setting a signaling frequency of the traffic control device based on the road congestion information. For example, the signaling frequency may include or correspond to signaling frequency 466 of FIG. 4. In some such implementations, setting the signaling frequency includes increasing the signaling frequency based on the road congestion information indicating a substantially consistent inter-vehicle spacing between the one or more vehicles and a decrease in vehicle density along a portion of a road. Alternatively, setting the signaling frequency may include decreasing the signaling frequency based on the road congestion information indicating a substantially consistent inter-vehicle spacing between the one or more vehicles and an increase in vehicle density along a portion of a road. Additionally or alternatively, controlling the traffic control device may further include causing the traffic control device to display a visual indicator (e.g., a green light, an image, particular text, etc.) according to the signaling frequency. Additionally or alternatively, controlling the traffic control device may further include causing the traffic control device to transmit traffic control messages to one or more additional vehicles according to the signaling frequency. The traffic control messages indicate permission to enter a road associated with the road congestion information. For example, the traffic control messages may include or correspond to traffic control messages 474 of FIG. 4.

In some implementations, controlling the traffic control device includes causing the traffic control device to indicate permission for a particular number of additional vehicles to enter a road based on the road congestion information associated with a portion of the road. For example, the particular number of vehicles may correspond to signaling count 468 of FIG. 4. In some such implementations, process 700 further includes determining the particular number of additional vehicles based on the inter-vehicle spacing indicated by the road congestion information, the vehicle speeds indicated by the road congestion information, or both. Additionally or alternatively, causing the traffic control device to indicate permission for the particular number of additional vehicles to enter the road includes causing the traffic control device to display a visual indicator associated with permission to enter the road for a time period that corresponds to the particular number of additional vehicles. For example, the traffic control device may display a visual indicator according to signaling count 468. Additionally or alternatively, causing the traffic control device to indicate permission for the particular number of additional vehicles to enter the road includes causing the traffic control device to transmit traffic control messages to the particular number of additional vehicles. The traffic control messages indicate permission to enter the road. For example, the traffic control messages include or correspond to traffic control messages 474 of FIG. 4.

In some implementations, the positioning request is transmitted periodically. For example, the positioning request includes or corresponds to positioning request 470 of FIG. 4, which may be periodically transmitted by network entity 450. In some such implementations, a transmission frequency of the positioning request is based on a time of day, a day of a week, a month of a year, or a combination thereof. Additionally or alternatively, a transmission frequency of the positioning request may be based on a vehicle density along a portion of a road that is indicated by the road congestion information. In some implementations, process 700 further includes receiving second position data associated with one or more second vehicles and updating the road congestion information based on the second position data. For example, road congestion information 464 of FIG. 4 may be updated based on periodic receipt of position data 406 and position data 472 due to periodic transmission of positioning request 470.

In some implementations, process 700 further includes determining a vehicle instruction associated with a first vehicle of the one or more vehicles based on the road congestion information and transmitting the vehicle instruction to the first vehicle. For example, the vehicle instruction may include or correspond to vehicle instructions 476 of FIG. 4. In some such implementations, the vehicle instruction indicates a particular inter-vehicle separation to be maintained between the first vehicle and any adjacent vehicles.

Additionally or alternatively, the vehicle instruction may indicate a particular speed to be maintained by the first vehicle. Additionally or alternatively, the vehicle instruction may indicate one or more actions for traversing an intersection of a road. In some implementations, the vehicle instruction is further determined based on a target fuel efficiency associated with the first vehicle, a target vehicle density for a portion of a road associated with the road congestion information, a target transit time associated with the first vehicle, or a combination thereof.

FIG. 8 is a block diagram of an example network entity 800 that supports sidelink positioning-based traffic control according to one or more aspects. Network entity 800 may be configured to perform operations, including the blocks of the process described with reference to FIG. 7. In some implementations, network entity 800 includes the structure, hardware, and components shown and described with reference to base station 105 of FIGS. 1-3, network entity 450 of FIG. 4, RSU 502 of FIG. 5A, RSU 522 of FIG. 5B, or RSU 542 of FIG. 5C. For example, network entity 800 may include controller 240, which operates to execute logic or computer instructions stored in memory 242, as well as controlling the components of network entity 800 that provide the features and functionality of network entity 800. Network entity 800, under control of controller 240, transmits and receives signals via wireless radios 801a-t and antennas 234a-t. Wireless radios 801a-t include various components and hardware, as illustrated in FIG. 2 for base station 105, including modulator and demodulators 232a-t, transmit processor 220, TX MIMO processor 230, MIMO detector 236, and receive processor 238.

As shown, the memory 242 may include road congestion information 802, traffic control logic 803, and communication logic 804. Road congestion information 802 may include or correspond to road congestion information 464 of FIG. 4. Traffic control logic 803 may be configured to enable control of a traffic control device that is integrated in or communicatively coupled to network entity 800. Communication logic 804 may be configured to enable communication between network entity 800 and one or more other devices. Network entity 800 may receive signals from or transmit signals to one or more UEs (e.g., UE 115), one or more base stations (e.g., base station 105), one or more network vehicles (e.g., vehicle 401, vehicles 510, additional vehicles 512, vehicles 530, additional vehicles 532, vehicles 550, or additional vehicles 532), or core network 130.

It is noted that one or more blocks (or operations) described with reference to FIG. 6 or 7 may be combined with one or more blocks (or operations) described with reference to another of the figures. For example, one or more blocks (or operations) of FIG. 6 may be combined with one or more blocks (or operations) of FIG. 7. As another example, one or more blocks associated with FIG. 7 may be combined with one or more blocks (or operations) associated with FIG. 6. Additionally, or alternatively, one or more operations described above with reference to FIG. 1-5C or 8 may be combined with one or more operations described with reference to FIGS. 6 and 7.

In one or more aspects, techniques for sidelink positioning-based traffic control may include additional aspects, such as any single aspect or any combination of aspects described below or in connection with one or more other processes or devices described elsewhere herein. In a first aspect, techniques for sidelink positioning-based traffic control may include receiving position data associated with one or more vehicles based on a positioning request. The techniques may further include controlling a traffic control device based on road congestion information. The road congestion information is based on the position data. In some examples, the techniques in the first aspect may be implemented in a method or process. In some other examples, the techniques of the first aspect may be implemented in a wireless communication device, such as a network entity, which may include an RSU, a component of an RSU, a base station, or a component of a base station. In some examples, the wireless communication device may include at least one processing unit or system (which may include an application processor, a modem or other components) and at least one memory device coupled to the processing unit. The processing unit or system may be configured to perform operations described herein with respect to the wireless communication device. In some examples, the memory device includes a non-transitory, computer-readable medium having program code stored thereon that, when executed by the processing unit or system, is configured to cause the wireless communication device to perform the operations described herein. Additionally, or alternatively, the wireless communication device may include an interface (e.g., a wireless communication interface) that includes a transmitter, a receiver, or a combination thereof. Additionally, or alternatively, the wireless communication device may include one or more means configured to perform operations described herein.

In a second aspect, in combination with the first aspect, the techniques also include determining positions of the one or more vehicles along a portion of a road based on the position data, speeds of the one or more vehicles, or a combination thereof, and determining the road congestion information based on the positions of the one or more vehicles, the speeds of the one or more vehicles, map data associated with the road, or a combination thereof.

In a third aspect, in combination with one or more of the first aspect or the second aspect, the road congestion information indicates vehicle density of the one or more vehicles along a portion of a road, vehicle speeds of the one or more vehicles, inter-vehicle spacing between the one or more vehicles, or a combination thereof.

In a fourth aspect, in combination with one or more of the first aspect through the third aspect, the techniques further include broadcasting the positioning request via a sidelink communication.

In a fifth aspect, in combination with one or more of the first aspect through the fourth aspect, the techniques further include transmitting the positioning request via a sidelink communication to a group of vehicles that are located within a particular range from a location of the network entity.

In a sixth aspect, in combination with one or more of the first aspect through the fifth aspect, the position data is received from the one or more vehicles via one or more sidelink communications.

In a seventh aspect, in combination with one or more of the first aspect through the sixth aspect, the position data is included in one or more basic safety messages (BSMs), one or more cooperative awareness messages (CAMs), or a combination thereof.

In an eighth aspect, in combination with one or more of the first aspect through the seventh aspect, controlling the traffic control device includes setting a signaling frequency of the traffic control device based on the road congestion information.

In a ninth aspect, in combination with the eighth aspect, setting the signaling frequency includes increasing the signaling frequency based on the road congestion information indicating a substantially consistent inter-vehicle spacing between the one or more vehicles and a decrease in vehicle density along a portion of a road.

In a tenth aspect, in combination with the eighth aspect, setting the signaling frequency includes decreasing the signaling frequency based on the road congestion information indicating a substantially consistent inter-vehicle spacing between the one or more vehicles and an increase in vehicle density along a portion of a road.

In an eleventh aspect, in combination with one or more of the eighth aspect through the tenth aspect, controlling the traffic control device further includes causing the traffic control device to display a visual indicator according to the signaling frequency.

In a twelfth aspect, in combination with one or more of the eighth aspect through the eleventh aspect, controlling the traffic control device further includes causing the traffic control device to transmit traffic control messages to one or more additional vehicles according to the signaling frequency. The traffic control messages indicate permission to enter a road associated with the road congestion information.

In a thirteenth aspect, in combination with one or more of the first aspect through the twelfth aspect, controlling the traffic control device includes causing the traffic control device to indicate permission for a particular number of additional vehicles to enter a road based on the road congestion information associated with a portion of the road.

In a fourteenth aspect, in combination with the thirteenth aspect, the road congestion information indicates inter-vehicle spacing between the one or more vehicles, vehicle speeds of the one or more vehicles, or both, and the techniques also include determining the particular number of additional vehicles based on the inter-vehicle spacing, the vehicle speeds, or both.

In a fifteenth aspect, in combination with one or more of the thirteenth aspect through the fourteenth aspect, controlling the traffic control device to indicate permission for the particular number of additional vehicles to enter the road includes causing the traffic control device to display a visual indicator associated with permission to enter the road for a time period that corresponds to the particular number of additional vehicles.

In a sixteenth aspect, in combination with one or more of the thirteenth aspect through the fifteenth aspect, controlling the traffic control device to indicate permission for the particular number of additional vehicles to enter the road includes causing the traffic control device to transmit traffic control messages to the particular number of additional vehicles. The traffic control messages indicate permission to enter the road.

In a seventeenth aspect, in combination with one or more of the first aspect through the sixteenth aspect, the network entity includes the traffic control device.

In an eighteenth aspect, in combination with one or more of the first aspect through the sixteenth aspect, the network entity is distinct from the traffic control device and is configured to control the traffic control device via communicating with the traffic control device.

In a nineteenth aspect, in combination with one or more of the first aspect through the eighteenth aspect, the positioning request is transmitted periodically.

In a twentieth aspect, in combination with the nineteenth aspect, a transmission frequency of the positioning request is based on a time of day, a day of a week, a month of a year, or a combination thereof.

In a twenty-first aspect, in combination with one or more of the nineteenth aspect through the twentieth aspect, a transmission frequency of the positioning request is based on a vehicle density along a portion of a road that is indicated by the road congestion information.

In a twenty-second aspect, in combination with one or more of the first aspect through the twenty-first aspect, the techniques further include receiving second position data associated with one or more second vehicles and updating the road congestion information based on the second position data.

In a twenty-third aspect, in combination with one or more of the first aspect through the twenty-second aspect, the techniques also include determining a vehicle instruction associated with a first vehicle of the one or more vehicles based on the road congestion information and transmitting the vehicle instruction to the first vehicle.

In a twenty-fourth aspect, in combination with the twenty-third aspect, the vehicle instruction indicates a particular inter-vehicle separation to be maintained between the first vehicle and any adjacent vehicles.

In a twenty-fifth aspect, in combination with one or more of the twenty-third aspect through the twenty-fourth aspect, the vehicle instruction indicates a particular speed to be maintained by the first vehicle.

In a twenty-sixth aspect, in combination with one or more of the twenty-third aspect through the twenty-fifth aspect, the vehicle instruction indicates one or more actions for traversing an intersection of a road.

In a twenty-seventh aspect, in combination with one or more of the twenty-third aspect through the twenty-sixth aspect, the vehicle instruction is further determined based on a target fuel efficiency associated with the first vehicle, a target vehicle density for a portion of a road associated with the road congestion information, a target transit time associated with the first vehicle, or a combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both.

To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof.

Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium.

Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation.

Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure.

Thus, the disclosure is not intended to be limited to the examples and designs described herein but is to be accorded the widest scope consistent with the principles and novel features disclosed herein.

What is claimed is:

1. A method of wireless communication performed by a network entity, the method comprising:
receiving position data associated with one or more vehicles based on a positioning request; and
controlling a traffic control device based on road congestion information, the road congestion information based on the position data.

2. The method of claim 1, further comprising:
determining positions of the one or more vehicles along a portion of a road based on the position data, speeds of the one or more vehicles, or a combination thereof; and
determining the road congestion information based on the positions of the one or more vehicles, the speeds of the one or more vehicles, map data associated with the road, or a combination thereof.

3. The method of claim 1, wherein the road congestion information indicates vehicle density of the one or more vehicles along a portion of a road, vehicle speeds of the one or more vehicles, inter-vehicle spacing between the one or more vehicles, or a combination thereof.

4. The method of claim 1, further comprising:
broadcasting the positioning request via a sidelink communication.

5. The method of claim 1, further comprising:
transmitting the positioning request via a sidelink communication to a group of vehicles that are located within a particular range from a location of the network entity.

6. The method of claim 1, wherein the position data is received from the one or more vehicles via one or more sidelink communications.

7. The method of claim 1, wherein the position data is included in one or more basic safety messages (BSMs), one or more cooperative awareness messages (CAMs), or a combination thereof.

8. The method of claim 1, wherein controlling the traffic control device includes setting a signaling frequency of the traffic control device based on the road congestion information.

9. The method of claim 8, wherein setting the signaling frequency includes increasing the signaling frequency based on the road congestion information indicating a substantially consistent inter-vehicle spacing between the one or more vehicles and a decrease in vehicle density along a portion of a road.

10. The method of claim 8, wherein setting the signaling frequency includes decreasing the signaling frequency based on the road congestion information indicating a substantially consistent inter-vehicle spacing between the one or more vehicles and an increase in vehicle density along a portion of a road.

11. The method of claim 8, wherein controlling the traffic control device further includes causing the traffic control device to display a visual indicator according to the signaling frequency.

12. The method of claim 8, wherein controlling the traffic control device further includes causing the traffic control device to transmit traffic control messages to one or more additional vehicles according to the signaling frequency, the traffic control messages indicating permission to enter a road associated with the road congestion information.

13. A network entity configured for wireless communication, the network entity comprising:
a memory storing processor-readable code; and
at least one processor coupled to the memory, the at least one processor configured to execute the processor-readable code to cause the at least one processor to:
receive position data associated with one or more vehicles based on a positioning request; and
control a traffic control device based on road congestion information, the road congestion information based on the position data.

14. The network entity of claim 13, wherein, to control the traffic control device, the at least one processor is configured to cause the traffic control device to indicate permission for a particular number of additional vehicles to enter a road based on the road congestion information associated with a portion of the road.

15. The network entity of claim 14, wherein the road congestion information indicates inter-vehicle spacing between the one or more vehicles, vehicle speeds of the one or more vehicles, or both, and wherein the at least one processor is further configured to:
determine the particular number of additional vehicles based on the inter-vehicle spacing, the vehicle speeds, or both.

16. The network entity of claim 14, wherein, to cause the traffic control device to indicate permission for the particular number of additional vehicles to enter the road, the at least one processor is configured to cause the traffic control device to display a visual indicator associated with permission to enter the road for a time period that corresponds to the particular number of additional vehicles.

17. The network entity of claim 14, wherein, to cause the traffic control device to indicate permission for the particular number of additional vehicles to enter the road, the at least one processor is configured to cause the traffic control device to transmit traffic control messages to the particular number of additional vehicles, the traffic control messages indicating permission to enter the road.

18. The network entity of claim 13, wherein the network entity comprises the traffic control device.

19. The network entity of claim 13, wherein the network entity is distinct from the traffic control device and configured to control the traffic control device via communicating with the traffic control device.

20. An apparatus for wireless communication, the apparatus comprising:
means for receiving position data associated with one or more vehicles based on a positioning request; and
means for controlling a traffic control device based on road congestion information, the road congestion information based on the position data.

21. The apparatus of claim 20, wherein the positioning request is transmitted periodically.

22. The apparatus of claim 21, wherein a transmission frequency of the positioning request is based on a time of day, a day of a week, a month of a year, or a combination thereof.

23. The apparatus of claim 21, wherein a transmission frequency of the positioning request is based on a vehicle density along a portion of a road that is indicated by the road congestion information.

24. A non-transitory, computer-readable medium storing instructions that, when executed by a processor, cause the processor to perform operations comprising:
receiving position data associated with one or more vehicles based on a positioning request; and
controlling a traffic control device based on road congestion information, the road congestion information based on the position data.

25. The non-transitory, computer-readable medium of claim 24, wherein the operations further comprise:
receiving second position data associated with one or more second vehicles; and
updating the road congestion information based on the second position data.

26. The non-transitory, computer-readable medium of claim 24, wherein the operations further comprise:
determining a vehicle instruction associated with a first vehicle of the one or more vehicles based on the road congestion information; and
transmitting the vehicle instruction to the first vehicle.

27. The non-transitory, computer-readable medium of claim 26, wherein the vehicle instruction indicates a particular inter-vehicle separation to be maintained between the first vehicle and any adjacent vehicles.

28. The non-transitory, computer-readable medium of claim 26, wherein the vehicle instruction indicates a particular speed to be maintained by the first vehicle.

29. The non-transitory, computer-readable medium of claim 26, wherein the vehicle instruction indicates one or more actions for traversing an intersection of a road.

30. The non-transitory, computer-readable medium of claim 26, wherein the vehicle instruction is further determined based on a target fuel efficiency associated with the first vehicle, a target vehicle density for a portion of a road associated with the road congestion information, a target transit time associated with the first vehicle, or a combination thereof.
